(19) United States
(12) Patent Application Publication
(10) Pub. No.: US 2009/0258222 A1
(43) Pub. Date: Oct. 15, 2009

(54) GLAZING PANEL

(75) Inventors: Philippe Roquiny, Jumet (BE); Jean-Michel Depauw, Jumet (BE)

Correspondence Address: OBLON, SPIVAK, MCCLELLAND MAIER & NEUSTADT, L.L.P., 1940 DUKE STREET, ALEXANDRIA, VA, 22314, US

(73) Assignee: AGC Flat Glass Europe S.A., bruxelles (BE)

(21) Appl. No.: 11/577,925

(22) PCT Filed: Oct. 8, 2005
(86) PCT No.: PCT/EP05/55816

§ 371 Date: Jun. 19, 2009

(30) Foreign Application Priority Data
Nov. 8, 2004 (EP) 04105583.1

(51) Int. Cl. B32B 5/00; B32B 17/06; B05D 5/06; B32B 9/04; B32B 15/04; C03B 27/00; C03B 23/023

(52) U.S. Cl. 428/336; 428/426; 428/432; 427/160; 428/446; 428/450; 65/104; 65/102

(57) ABSTRACT

A glazing panel has a coating stack comprising in sequence at least a base antireflective layer, an infra-red reflecting layer, a top antireflective layer and a top coat layer comprising in sequence at least two sublayers: a first one consisting essentially of at least one material selected from the group consisting of titanium, titanium oxide and titanium nitride, and a second one, consisting essentially of silicon oxide, silicon nitride, silicon oxynitride, silicon carbide, silicon carbonitride, silicon oxycarbide, or silicon oxycarbonitride. The second topcoat sublayer may have a geometrical thickness in the ranges 15 to 30 Å or 200 to 400 Å.

This invention relates to glazing panels and particularly, but not exclusively, to solar control and/or low emissivity glazing panels and/or glazing panels which may undergo heat treatment following application to the glazing substrate of an optical filter in the form of a coating stack. The invention relates more particularly to cases where a coating stack is applied to the glazing by a vacuum deposition technique, for example by sputtering or magnetron sputtering.

Multiple factors must be considered when designing coating stacks for glazing applications. These include not only the desired opto-energetic performance of the coated glazing panel but also, for example, the abrasion resistance of the coating stack (to facilitate handling, transport and processing), the stability and chemical durability of the coating stack (to facilitate storage under various conditions) and the tolerances of the control of the manufacturing process (to facilitate acceptable manufacturing yields and consistency between product runs).

It is known to apply a top coat to a coating stack particularly in an attempt to increase the abrasion resistance and/or chemical durability of a coating stack. GB 2,293,179 relates to a protective additional layer for improving chemical and mechanical durability of coated substrates, while minimising any consequential changes in the optical properties. This protective layer is formed of oxides or oxynitrides of silicon, or mixtures of one or more of oxides, nitrides and oxynitrides of silicon, and has a thickness of from 10 to 100 Å.

However we have found that such protective additional layer like the one described in GB 2,293,179, when deposited on some coating stacks, for example on a coating stack of the type “base antireflective layer/infra-red reflecting layer/top antireflective layer/top coat layer consisting essentially of at least one material selected from the group consisting of titanium, titanium oxide and titanium nitride”, was not always offering a good resistance during transport and that scratches might appear at the surface of the coating. Scratches turned out to be even more numerous and visible when the coated glazing panel was heat-treated after its transport. By transport, it is meant herein transfer for example by trucks, in piles or boxes, from, for example, coater to wholesaler or transformer or to tempering furnace.

The present invention provides glazing panels, a method of manufacturing glazing panels and use of a top coat layer as defined in the independent claims. Preferred embodiments are defined in the dependent claims.

The present invention may provide an advantageous combination of good mechanical resistance, particularly good resistance to scratches during transport, heat treatability, chemical durability, humidity resistance and stability of manufacturing parameters.

The topcoat layer may advantageously be a combination of at least two sublayers: the first topcoat sublayer is thought to provide inter alia a “reserve” useful when the glazing panel is to be heat-treated to ensure thermal protection to other parts of the coating stack during heat-treatment; and the second topcoat sublayer is thought to provide inter alia a mechanical protection to the coated glazing panel.

It has been found advantageous that the top coat layer comprises a first topcoat sublayer, underneath the second topcoat sublayer, consisting essentially of at least one material selected from the group consisting of titanium, titanium oxide and titanium nitride. One advantage of the first topcoat sublayer of the present invention is that it may provide to the glazing panel a particularly good chemical durability during storage, for example prior to heat treatment and/or assembly, with a facility to control the manufacturing tolerances and production process. This may be combined with an ability to provide thermal protection to other parts of the coating stack during heat treatment. Preferably, the first and second topcoat sublayers are in direct contact with each other, but in other embodiments, a further sublayer may be present between them. Still preferably, the top coat layer consists of two topcoat sublayers. However, in some embodiments, the top coat layer may comprise additional sublayers, for example under the first topcoat sublayer.

The first topcoat sublayer may comprise a material other than those cited above, for example, it may consist of, comprise or be based on:
Ti, Zr, Hf, V, Nb, Ta, Cr or their mixtures or a mixture of at least one of those metals with Al and/or B or
an oxide, a sub-stoichiometric oxide, a nitride or an oxynitride of Ti, Zr, Hf, V, Nb, Ta, Cr or their mixtures, or an oxide, a sub-stoichiometric oxide, a nitride or an oxynitride which is a mixture of at least one of those metals with Al and/or B.

The first topcoat sublayer may have a geometrical thickness in the range 20 to 100 Å, preferably in the range 20 to 80 Å or 20 to 50 Å or 20 to 40 Å or 20 to 30 Å, and still more preferably in the range 25 to 30 Å. Thicknesses of at least 20 Å may allow to avoid damages when heat-treating the glazing panel and thicknesses of no more than 100 Å, preferably 80 Å or 50 Å, may avoid a too great decrease in the luminous transmittance of the coated glazing panel.

The second topcoat sublayer may consist essentially of silicon oxide, silicon nitride, silicon oxynitride, silicon carbide, silicon carbonitride, silicon oxycarbide, or silicon oxycarbonitride. Preferably, this layer is deposited by a vacuum deposition technique, particularly magnetron sputtering. The target used to deposit such a layer may be made of pure Si or Si doped with for example one or more of Al (for example 8% Al in the Si target), Zr, Ti, NiCr, Ni, B or Sb, as is well-known in the art. The second topcoat sublayer may consequently incorporate relatively small amounts of such doping agent without departing from this invention. Targets of SiC, like target FG90 of Carborundum Company, may also be used.

The geometrical thickness of the second topcoat sublayer is advantageously in the range 10 to 50 Å, preferably in the range 10 to 40 Å, still more preferably in the range 15 to 30 A. Below 10 Å, the second topcoat sublayer may not be sufficiently thick to protect the coating stack against scratches, for example during transport. Furthermore, when the coated glazing panel is heat-treated after its formation or after its formation and transport, we have found that thicknesses of the second topcoat sublayer above 50 Å may provoke inacceptable scratches. These last scratches, appearing after a heat-treatment of the coated glazing panel, seem to be actually “dendrites” revealing fragility zones in the coating, i.e. a weakness of the coating itself when undergoing a heat-treatment. Such dendrites seem to form along the paths where a mechanical contact has been done prior to heat-treatment, showing, at macroscopic level, “scratches” which render the glazing panel unusable. When the first topcoat sublayer consists of, comprises or is based on Ti or one of its compound cited above, the geometrical thickness of the second topcoat sublayer is advantageously in the range 15 to 30 Å, preferably in the range 15 to 25 Å.

Preferably, when the second topcoat sublayer consists essentially of silicon oxide, this oxide is fully oxidised; this may give optical advantages to the coating stack, a layer of fully oxidised silicon oxide having a lower impact on the colour, for example, of the entire coating stack. Alternatively, the second topcoat sublayer may consist essentially of sub-stoichiometric silicon oxide.

Preferably, the second topcoat sublayer is exposed to air, i.e. is the outermost layer of the coating stack. This may provide particularly good results in terms of mechanical resistance and heat-treatability.

It is also possible for the second topcoat sublayer to be used without a first topcoat sublayer.

In a preferred embodiment, the topcoat layer comprises a first topcoat sublayer consisting essentially of titanium nitride, having a geometrical thickness in the range 20 to 40 Å, and a second topcoat sublayer consisting essentially of silicon oxide, having a geometrical thickness in the range 15 to 25 Å.

The combination of properties that may be provided by the present invention have particular advantages in relation to heat treatable and heat treated glazing panels. Nevertheless, the invention may also be used in respect of glazings which are not heat treated. The term “heat treatable glazing panel” as used herein means that the glazing panel carrying the coating stack is adapted to undergo a bending and/or thermal tempering and/or thermal hardening operation and/or other heat treatment process without the haze of the so treated glazing panel exceeding 0.5, and preferably without the haze exceeding 0.3. Such heat treatment processes may involve heating or exposing the glazing carrying the coating stack or to a temperature greater than about 560° C., for example, between 560° C. and 700° C. in the atmosphere. Other such heat treatment processes may be sintering of a ceramic or enamel material, vacuum sealing of a double glazing unit and calcination of a wet-coated low reflective coating or anti-glare coating. The heat treatment process, especially when this is a bending and/or thermal tempering and/or thermal hardening operation, may be carried out at a temperature of at least, 600° C. for at least 10 minutes, 12 minutes, or 15 minutes, at least 620° C. for at least 10 minutes, 12 minutes, or 15 minutes, or at least 640° C. for at least 10 minutes, 12 minutes, or 15 minutes.

The coating layers are preferably deposited by a vacuum deposition technique, particularly magnetron sputtering.

Glazing panels according to the invention may comprise one or more infra-red reflecting layers. These layers, which may be made of silver for example, act to reflect incident infra-red radiation. The dielectric antireflective layers which sandwich the infra-red reflecting layers serve to reduce the reflection of the visible portion of the spectrum which the silver layers would otherwise provoke.

Each antireflective dielectric layer may consist of a single layer or may comprise two or more sub-layers which together form the antireflective dielectric layer. The antireflective dielectric layers, or at least portion of the antireflective dielectric layers may comprise an oxide, for example an oxide comprising zinc and tin and/or zinc and aluminium.

The coating stack may comprise one or more barrier layers underlying and/or overlying the infra red reflecting layer, as is known in the art. Barriers of, for example, one or more of the following material may be used: Ti, Zn, Cr, “stainless steel”, Zr, Nb, Ni, NiCr, NiTi, ZnTi and ZnAl. Such barriers may be deposited as metallic layers, as sub-oxides (i.e. partially oxidised layers) or as fully oxidised oxides. Alternatively, nitrided barrier layers may also be used. Each barrier layer may consist of a single layer or may comprise two or more sub-layers which together form the barrier layer. The barrier layer may comprise a first barrier layer in substantially metallic form, e.g. comprising nickel and chromium, and an overlying second barrier layer of a different composition from the first barrier layer (e.g. comprising titanium) which is in a form selected from the group consisting of oxides, sub-stoichiometric oxides, nitrides, sub-stoichiometric nitrides, oxynitrides and sub-stoichiometric oxynitrides.

In one embodiment of the invention, the second topcoat sublayer may have a geometrical thickness in the range 200 to 400 Å, preferably 250 to 350 Å, or still more preferably, around 300 Å. We have surprisingly found that such a range of thicknesses may offer good mechanical properties and may reduce or avoid the apparition of scratches after heat-treatment of the glazing panel. However, such thicknesses may increase the cost of production and may also necessitate that the entire coating stack be reviewed, for examples in terms of thicknesses of layers, to avoid, for example, colour changes.

We have observed that the best tool to simulate what a coated glazing panel undergoes when it is transported, is the Automatic Web Rub Test (AWRT). A piston covered with a cotton cloth (reference: CODE 40700004 supplied by ADSOL) is put in contact with the coating and oscillates over the surface. The piston carries a weight in order to have a force of 33N acting on a 17 mm diameter finger. The abrasion of the cotton over the coated surface will damage (remove) the coating after a certain number of cycles. The test is used to define the threshold before the coating discolours (removal of top layer) and before scratches appear in the coating. The test is realised for 10, 50, 100, 250, 500 and 1000 cycles, at separated distances over the sample. The sample is observed under an artificial sky to determine whether discoloration and/or scratches can be seen on the sample. The AWRT score indicates the number of cycles giving no or very light degradation (not visible with naked eye under uniform artificial sky at 80 cm distance from the sample). A “−” or a “+” is indicated after the AWRT score depending respectively if light scratches are appearing or not at all. Preferably, glazing panels according to the invention show AWRT values of at least 250, more preferably at least 500.

The coating stack of the glazing panel of the present invention may be such that if applied to a clear sheet of 4 mm glass it would give a TL measured with Illuminant C of greater than about 25%, 30%, 35%, 40%, 45%, 55%, 60%, 65%, 70%, 75%, 80%, 85% or 90%. Heat treatment may provoke an increase in the luminous transmittance (TL) of the glazing panel. Such an increase in TL may be advantageous in ensuring that TL is sufficiently high for the glazing panel to be used in high light transmittance glazings, for example, in vehicle windscreens or in architectural applications where the monolithic coated glazing panel is desired to have a TL greater than about 25%, 30%, 35%, 40%, 45%, 55%, 60%, 65%, 70%, 75%, 80%, 85% or 90% or in double glazing units where the double glazing unit is desired to have a TL greater than about 55%, 60%, 65%, 70%, 75%, 80% or 85%. TL may increase in absolute terms during heat treatment by, for example, greater than about 2.5%, greater than about 3%, greater than about 4%, greater than about 6%, greater than about 8% or greater than about 10%.

Glazing panels according to the invention may be suitable for assembly in a double glazing unit. They may be adapted, for example, for assembly in a double glazing unit with the coating stack in position 3 (interior surface of interior sheet of glass) or in position 2 (interior surface of exterior sheet of glass). At least one of the glazing panels forming the double glazing unit may be heat-treated before its assembly in the double glazing unit.

Embodiments of the invention will now be further described, by way of example only, along with comparative examples.

Coating stacks have been deposited by magnetron sputtering on glass substrates, according to the tables hereunder. The coating stacks are all described as they exit from the magnetron sputtering coater. Glass thickness is for all examples 6 mm except for example 9, where it is 2.6 mm. Similar results are to be expected on glass of other thickness, for example 4 mm.

In examples 1 to 6 and 11 and comparative examples 1 to 11, the coating stack is always the same, except for the topcoat layer. The antireflective layers comprise mixed oxides of zinc and tin in various proportions: Zn(50)Sn(50)Ox meaning a mixed oxide with 50% Zn and 50% Sn and Zn(90)Sn(10)Ox meaning a mixed oxide with 90% Zn and 10% Sn. Actually, the exact composition of the target used to give the Zn(50)Sn(50)Ox layer is Zn:52% Sn:48% by weight of these metals in the target. It corresponds to the composition which allows easily to form a zinc stannate, known in the art for its blocking properties during thermal treatments.

Comparative examples 1 and 2 illustrate that a topcoat layer comprising a single sublayer of TiN show poor results in AWRT test, the coating being deteriorated after less than 50 cycles, even when the thickness of the TiN sublayer is higher.

Comparative examples 3 to 7 and examples 1 to 3 illustrate the addition of a second topcoat sublayer of SiO2 above a first topcoat sublayer of TiN, this SiO2 sublayers showing different thicknesses. Comparative example 3 shows that the addition of a 10 A SiO2 topcoat sublayer does not offer better results in AWRT test. Examples 1 to 3 and comparative examples 4 to 7 show however similar and good AWRT results, with SiO2 topcoat sublayers from 15 to 300 A. These coating stacks nevertheless differentiate each other in their ability to be heat-treated, for example tempered, without showing scratches after tempering. Comparative examples 4 to 7, with SiO2 thicknesses between 36 and 100 Å, show scratches both after tempering, and after transport (simulated by an AWRT test) and tempering. Whereas example 1, 2 and 3, with SiO2 thicknesses of 15, 25 and 300 Å, offer the advantage of resisting well to AWRT test, and thus transport, and showing no scratches after tempering. These examples, which are part of this invention, are thus coatings offering a good mechanical resistance, e.g. a good resistance to transport, having the advantage of being heat-treatable. With reference to example 3, note that due to the higher thickness of SiO2, a colour change may appear compared to the coated glazing panel without the SiO2 sublayer. This may be corrected by adjusting the thicknesses of the other layers forming the coating stack, without impairing the advantages of good mechanical resistance and heat-treatability of the stack with the SiO2 topcoat sublayer.

Comparative examples 8, 9 and 11 illustrate the advantage of a first topcoat sublayer of TiN for ensuring a good heat-treatability and stability of the coated glazing panel.

Comparative example 10 illustrates the advantage of having, in order, the second topcoat sublayer of SiO2 above the first topcoat sublayer of TiN.

Examples 4, 5 and 6 illustrate other embodiments of the invention: a first topcoat sublayer of Ti, or a second topcoat sublayer of SiC. Example 4 shows before heat-treatment a luminous transmittance of 82%, an emissivity of 0.070 and an electrical resistance of 6Ω/□, and after heat-treatment, a luminous transmittance of 89%, an emissivity of 0.045 and an electrical resistance of 4.5Ω/□. Example 6 shows a luminous transmittance of 78% before heat-treatment, and of 89% after heat-treatment. Example 11 illustrates a first topcoat sublayer of Zr.

Examples 7 to 9 illustrate the application of the invention to double silver coating stacks, with different first topcoat sublayers, i.e. TiN, Ti, TiO2. Examples 7 and 8 are heat-treatable coatings offering a high selectivity; they show a luminous transmittance of 74% before tempering and of 81% after tempering, an emissivity of 0.018 and an electrical resistance per square of 1.6Ω/□. A glazing panel according to example 9 may be used in the manufacture of a heatable solar-control windscreen for cars. Such windscreen shows a luminous transmittance of 77% under illuminant A, an energetic transmittance of 44% and an electrical resistance per square of 2.2 Ω/□.

Example 10 is a transport test of glazing panels according to the invention (sheets of glass bearing a coating stack according to example 1, except that the thickness of SiO2 was 20 Å) and of glazing panels not in accordance with the invention (sheets of glass bearing a coating stack according to comparative example 2). All these sheets of glass were subjected to the following steps:
Gathering of the glass sheets into piles of 2.5 T each, with 200 mg of interlaying powder by m² of glass between the sheets of glass.
Shipping after 3-months stocking
Loading in trucks with cardboard spacers between the piles
Pressure in the cushions of 4 bars
Journey of more than 1000 km, passing through the Alps, which is a critical case because of the road curves and the abrupt changes in temperature
Inspection of the glass sheets under a spot light: good result (no scratches, no discolouration) for the glass sheets with the SiO2 topcoat sublayer, contrary to the glass sheets without the SiO2 topcoat sublayer
Travel back to point of departure, new inspection, and always good result for the glass sheets with the SiO2 topcoat sublayer
Shipping of the glass sheets with the SiO2 topcoat sublayer which have travel as hereinabove described, to a tempering furnace, 6 months after the glass sheets have been coated
Handling, cutting, processing of the glass sheets
Tempering
At the oven exit, no mechanical defect visible at the naked eye.

| | Comp. Example 1 | | Comp. Example 2 | | Comp. Example 3 | | Example 1 | |
|---|---|---|---|---|---|---|---|---|
| glass substrate | glass | 6 mm | glass | 6 mm | glass | 6 mm | glass | 6 mm |
| base anti- | Zn(50)Sn(50)Ox | 275 Å | Zn(50)Sn(50)Ox | 275 Å | Zn(50)Sn(50)Ox | 275 Å | Zn(50)Sn(50)Ox | 275 Å |
| reflective | Zn(90)Sn(10)Ox | 100 Å | Zn(90)Sn(10)Ox | 100 Å | Zn(90)Sn(10)Ox | 100 Å | Zn(90)Sn(10)Ox | 100 Å |
| layer | | | | | | | | |
| infra-red | Ag | 107 Å | Ag | 107 Å | Ag | 107 Å | Ag | 107 Å |
| reflecting | | | | | | | | |
| layer | | | | | | | | |
| barrier | NiCr | 10 Å | NiCr | 10 Å | NiCr | 10 Å | NiCr | 10 Å |
| layer | TiO2 | 25 Å | TiO2 | 25 Å | TiO2 | 25 Å | TiO2 | 25 Å |
| top anti- | Zn(90)Sn(10)Ox | 100 Å | Zn(90)Sn(10)Ox | 100 Å | Zn(90)Sn(10)Ox | 100 Å | Zn(90)Sn(10)Ox | 100 Å |
| reflective | Zn(50)Sn(50)Ox | 275 Å | Zn(50)Sn(50)Ox | 275 Å | Zn(50)Sn(50)Ox | 275 Å | Zn(50)Sn(50)Ox | 275 Å |
| layer | | | | | | | | |
| topcoat | TiN | 25 Å | TiN | 35 Å | TiN | 36 Å | TiN | 36 Å |
| layer | | | | | SiO2 | 10 Å | SiO2 | 15 Å |
| AWRT result | 50− | | 50− | | 50− | | 500− | |
| on non heat- | | | | | | | | |
| treated coated | | | | | | | | |
| glass¹ | | | | | | | | |
| Observation | no scratches | | no scratches | | no scratches | | no scratches | |
| after tempering² | | | | | | | | |
| without transport | | | | | | | | |
| before tempering | | | | | | | | |
| Observation | scratches | | scratches | | scratches | | no scratches | |
| after AWRT test³ | | | | | | | | |
| and tempering⁴ | | | | | | | | |
| | Example 2 | | Comp. Example 4 | | Comp. Example 5 | | Comp. Example 6 | |
| glass substrate | glass | 6 mm | glass | 6 mm | glass | 6 mm | glass | 6 mm |
| base anti- | Zn(50)Sn(50)Ox | 275 Å | Zn(50)Sn(50)Ox | 275 Å | Zn(50)Sn(50)Ox | 275 Å | Zn(50)Sn(50)Ox | 275 Å |
| reflective | Zn(90)Sn(10)Ox | 100 Å | Zn(90)Sn(10)Ox | 100 Å | Zn(90)Sn(10)Ox | 100 Å | Zn(90)Sn(10)Ox | 100 Å |
| layer | | | | | | | | |
| infra-red | Ag | 107 Å | Ag | 107 Å | Ag | 107 Å | Ag | 107 Å |
| reflecting | | | | | | | | |
| layer | | | | | | | | |
| barrier | NiCr | 10 Å | NiCr | 10 Å | NiCr | 10 Å | NiCr | 10 Å |
| layer | TiO2 | 25 Å | TiO2 | 25 Å | TiO2 | 25 Å | TiO2 | 25 Å |
| top anti- | Zn(90)Sn(10)Ox | 100 Å | Zn(90)Sn(10)Ox | 100 Å | Zn(90)Sn(10)Ox | 100 Å | Zn(90)Sn(10)Ox | 100 Å |
| reflective | Zn(50)Sn(50)Ox | 275 Å | Zn(50)Sn(50)Ox | 275 Å | Zn(50)Sn(50)Ox | 275 Å | Zn(50)Sn(50)Ox | 275 Å |
| layer | | | | | | | | |
| topcoat | TiN | 36 Å | TiN | 36 Å | TiN | 36 Å | TiN | 36 Å |
| layer | SiO2 | 25 Å | SiO2 | 36 Å | SiO2 | 40 Å | SiO2 | 60 Å |

| | | | | |
|---|---|---|---|---|
| AWRT result | 500− | 500− | 500− | 500 |
| on non heat- | | | | |
| treated coated | | | | |
| glass¹ | | | | |
| Observation | no scratches | lot of scratches | fine scratches | fine scratches |
| after tempering² | | | | |
| without transport | | | | |
| before tempering | | | | |
| Observation | no scratches | scratches | scratches | scratches |
| after AWRT test³ | | | | |
| and tempering⁴ | | | | |

layers thicknesses are geometrical thicknesses
thicknesses given for the first topcoat sublayer comprising TiN or Ti are given as equivalent TiO2 (19 Å TiO2 correspond to 10 Å TiN)
¹the AWRT score indicates the number of cycles giving no or very light degradation (not visible with naked eye under uniform artificial sky at 80 cm distance from the sample). We indicate a “−” or a “+” depending if light scratches are appearing or not at all.
²660°-670° during 6 min 20
³AWRT test 100 cycles
⁴670° during 10 min 30

| | Comp. Example 7 | | Example 3 | | Comp. Example 8 | |
|---|---|---|---|---|---|---|
| glass substrate | glass | 6 mm | glass | 6 mm | glass | 6 mm |
| base anti- | Zn(50)Sn(50)Ox | 275 Å | Zn(50)Sn(50)Ox | 275 Å | Zn(50)Sn(50)Ox | 275 Å |
| reflective | Zn(90)Sn(10)Ox | 100 Å | Zn(90)Sn(10)Ox | 100 Å | Zn(90)Sn(10)Ox | 100 Å |
| layer | | | | | | |
| infra-red | Ag | 107 Å | Ag | 107 Å | Ag | 107 Å |
| reflecting | | | | | | |
| layer | | | | | | |
| barrier | NiCr | 10 Å | NiCr | 10 Å | NiCr | 10 Å |
| layer | TiO2 | 25 Å | TiO2 | 25 Å | TiO2 | 25 Å |
| top anti- | Zn(90)Sn(10)Ox | 100 Å | Zn(90)Sn(10)Ox | 100 Å | Zn(90)Sn(10)Ox | 100 Å |
| reflective | Zn(50)Sn(50)Ox | 275 Å | Zn(50)Sn(50)Ox | 275 Å | Zn(50)Sn(50)Ox | 275 Å |
| layer | | | | | | |
| topcoat | TiN | 36 Å | TiN | 36 Å | SiO2 | <100 Å |
| layer | SiO2 | 100 Å | SiO2 | 300 Å | | |
| AWRT result | 500− | | 500 | | | |
| on non heat- | | | | | | |
| treated coated | | | | | | |
| glass¹ | | | | | | |
| Observation | fine scratches | | no scratches | | lot of scratches | |
| after tempering² | | | I Colour shift => | | | |
| without transport | | | review the stack | | | |
| before tempering | | | | | | |
| Observation | scratches | | some scratches | | lot of haze | |
| after AWRT test³ | | | | | | |
| and tempering⁴ | | | | | | |
| | Comp. Example 9 | | Comp. Example 10 | | Example 4 | |
| glass substrate | glass | 6 mm | glass | 6 mm | glass | 6 mm |
| base anti- | Zn(50)Sn(50)Ox | 275 Å | Zn(50)Sn(50)Ox | 275 Å | Zn(50)Sn(50)Ox | 275 Å |
| reflective | Zn(90)Sn(10)Ox | 100 Å | Zn(90)Sn(10)Ox | 100 Å | Zn(90)Sn(10)Ox | 100 Å |
| layer | | | | | | |
| infra-red | Ag | 107 Å | Ag | 107 Å | Ag | 107 Å |
| reflecting | | | | | | |
| layer | | | | | | |
| barrier | NiCr | 10 Å | NiCr | 10 Å | NiCr | 10 Å |
| layer | TiO2 | 25 Å | TiO2 | 25 Å | TiO2 | 25 Å |
| top anti- | Zn(90)Sn(10)Ox | 100 Å | Zn(90)Sn(10)Ox | 100 Å | Zn(90)Sn(10)Ox | 100 Å |
| reflective | Zn(50)Sn(50)Ox | 275 Å | Zn(50)Sn(50)Ox | 275 Å | Zn(50)Sn(50)Ox | 275 Å |
| layer | | | | | | |
| topcoat | SiO2 | 300 Å | SiO2 | 100 Å | Ti | 50 Å |
| layer | | | TiN | 30 Å | SiO2 | 25 Å |
| AWRT result | 500+ | | 250− | | 500− | |
| on non heat- | | | | | | |
| treated coated | | | | | | |
| glass¹ | | | | | | |
| Observation | colour shift | | scratches | | haze/no scratches | |
| after tempering² | | | | | | |
| without transport | | | | | | |
| before tempering | | | | | | |
| Observation | some scratches | | scratches | | haze/no scratches | |
| after AWRT test³ | | | | | | |
| and tempering⁴ | | | | | | |
| | Example 5 | | Comp. Example 11 | | Example 6 | |
| glass substrate | glass | 6 mm | glass | 6 mm | glass | 6 mm |
| base anti- | Zn(50)Sn(50)Ox | 275 Å | Zn(50)Sn(50)Ox | 275 Å | Zn(50)Sn(50)Ox | 275 Å |
| reflective | Zn(90)Sn(10)Ox | 100 Å | Zn(90)Sn(10)Ox | 100 Å | Zn(90)Sn(10)Ox | 100 Å |
| layer | | | | | | |
| infra-red | Ag | 107 Å | Ag | 107 Å | Ag | 107 Å |
| reflecting | | | | | | |
| layer | | | | | | |
| barrier | NiCr | 10 Å | NiCr | 10 Å | NiCr | 10 Å |
| layer | TiO2 | 25 Å | TiO2 | 25 Å | TiO2 | 25 Å |
| top anti- | Zn(90)Sn(10)Ox | 100 Å | Zn(90)Sn(10)Ox | 100 Å | Zn(90)Sn(10)Ox | 100 Å |
| reflective | Zn(50)Sn(50)Ox | 275 Å | Zn(50)Sn(50)Ox | 275 Å | Zn(50)Sn(50)Ox | 275 Å |
| layer | | | | | | |
| topcoat | Ti | 40 Å | Si3N4 | <10 Å | TiN | 35 Å |
| layer | SiO2 | 20 Å | | | SiC | 17 Å |

| | | | |
|---|---|---|---|
| AWRT result | 500− | 500+ | 500− |
| on non heat- | | | |
| treated coated | | | |
| glass¹ | | | |
| Observation | no scratches | lot of scratches | no scratches |
| after tempering² | | | |
| without transport | | | |
| before tempering | | | |
| Observation | no scratches | scratches | no scratches |
| after AWRT test³ | | | |
| and tempering⁴ | | | |

layers thicknesses are geometrical thicknesses
thicknesses given for the first topcoat sublayer comprising TiN or Ti are given as equivalent TiO2 (19 Å TiO2 correspond to 10 Å TiN)
¹the AWRT score indicates the number of cycles giving no or very light degradation (not visible with naked eye under uniform artificial sky at 80 cm distance from the sample). We indicate a “−” or a “+” depending if light scratches are appearing or not at all.
²660°-670° during 6 min 20
³AWRT test 100 cycles
⁴670° during 10 min 30

| | Example 7 | | Example 8 | | Example 9 | | Example 11 | |
|---|---|---|---|---|---|---|---|---|
| glass substrate | glass | 6 mm | glass | 6 mm | glass | 2.6 mm | glass | 6 mm |
| base anti- | Zn(50)Sn(50)Ox | 200 Å | Zn(50)Sn(50)Ox | 200 Å | Zn(50)Sn(50)Ox | 180 Å | Zn(50)Sn(50)Ox | 275 Å |
| reflective | Zn(90)Sn(10)Ox | 130 Å | Zn(90)Sn(10)Ox | 130 Å | Zn(90)Sn(10)Ox | 120 Å | Zn(90)Sn(10)Ox | 100 Å |
| layer | | | | | | | | |
| infra-red | Ag | 110 Å | Ag | 110 Å | Ag | 130 Å | Ag | 107 Å |
| reflecting | | | | | | | | |
| layer | | | | | | | | |
| barrier | NiCr | 10 Å | NiCr | 10 Å | Ti | 20 Å | NiCr | 10 Å |
| layer | TiO2 | 25 Å | TiO2 | 25 Å | TiO2 | 25 Å | TiO2 | 25 Å |
| central anti- | Zn(50)Sn(50)Ox | 680 Å | Zn(50)Sn(50)Ox | 680 Å | Zn(50)Sn(50)Ox | 660 Å | | |
| reflective | Zn(90)Sn(10)Ox | 110 Å | Zn(90)Sn(10)Ox | 110 Å | Zn(90)Sn(10)Ox | 100 Å | | |
| layer | | | | | | | | |
| infra-red | Ag | 155 Å | Ag | 155 Å | Ag | 155 Å | | |
| reflecting | | | | | | | | |
| layer | | | | | | | | |
| barrier | NiCr | 10 Å | NiCr | 10 Å | Ti | 20 Å | | |
| layer | TiO2 | 25 Å | TiO2 | 25 Å | TiO2 | 25 Å | | |
| top anti- | Zn(90)Sn(10)Ox | 80 Å | Zn(90)Sn(10)Ox | 80 Å | Zn(90)Sn(10)Ox | 60 Å | Zn(90)Sn(10)Ox | 100 Å |
| reflective | Zn(50)Sn(50)Ox | 200 Å | Zn(50)Sn(50)Ox | 190 Å | Zn(50)Sn(50)Ox | 120 Å | Zn(50)Sn(50)Ox | 275 Å |
| layer | | | | | | | | |
| topcoat | TiN | 40 Å | Ti | 46 Å | TiO2 | 55 Å | Zr | 40 Å |
| layer | SiO2 | 21 Å | SiO2 | 18 Å | SiO2 | 17 Å | SiO2 | 20 Å |

| | | | | |
|---|---|---|---|---|
| AWRT result | 500− | 500− | 500− | 500− |
| on non heat- | | | | |
| treated coated | | | | |
| glass¹ | | | | |
| Observation | no scratches | no scratches | no scratches | no scratches |
| after tempering² | | | | |
| without transport | | | | |
| before tempering | | | | |
| Observation | no scratches | no scratches | no scratches | no scratches |
| after AWRT test³ | | | | |
| and tempering⁴ | | | | |

layers thicknesses are geometrical thicknesses
thicknesses given for the first topcoat sublayer comprising TiN or Ti, or Zr, are given respectively as equivalent TiO2 (19 Å TiO2 correspond to 10 Å TiN), or ZrO2.
¹the AWRT score indicates the number of cycles giving no or very light degradation (not visible with naked eye under uniform artificial sky at 80 cm distance from the sample). We indicate a “−” or a “+” depending if light scratches are appearing or not at all.
²660°-670° during 6 min 20
³AWRT test 100 cycles
⁴670° during 10 min 30

1. A glazing panel carrying a coating stack comprising in sequence at least:
a glass substrate
a base antireflective layer
an infra-red reflecting layer
a top antireflective layer
a top coat layer
in which the top coat layer comprises at least two sublayers:
a first topcoat sublayer consisting essentially of at least one material selected from the group consisting of Ti, Zr, Hf, V, Nb, Ta, Cr or their mixtures or a mixture of at least one of those metals with At and/or B or an oxide, a sub-stoichiometric oxide, a nitride or an oxynitride of Ti, Zr, Hf, V, Nb, Ta, Cr or their mixtures, or an oxide, a sub-stoichiometric oxide, a nitride or an oxynitride which is a mixture of at least one of those metals with Al and/or B, and
a second topcoat sublayer, above the first top coat sublayer, consisting essentially of silicon oxide, silicon sub-stoichiometric oxide, silicon oxynitride, silicon carbide, silicon carbonitride, silicon oxycarbide, or silicon oxycarbonitride.

2. A glazing panel according to claim 1, in which the second topcoat sublayer has a geometrical thickness in the range 15 to 30 Å.

3. A glazing panel according to claim 1, in which the second topcoat sublayer has a geometrical thickness in the range 200 to 400 Å.

4. A glazing panel carrying a coating stack comprising in sequence at least:
a glass substrate
a base antireflective layer
an infra-red reflecting layer
a top antireflective layer
a top coat layer
in which the top coat layer comprises at least two sublayers:
a first topcoat sublayer consisting essentially of at least one material selected from the group consisting of Ti, Zr, Hf, V, Nb, Ta, Cr or their mixtures or a mixture of at least one of those metals with Al and/or B or an oxide, a sub-stoichiometric oxide, a nitride or an oxynitride of Ti, Zr, Hf, V, Nb, Ta, Cr or their mixtures, or an oxide, a sub-stoichiometric oxide, a nitride or an oxynitride which is a mixture of at least one of those metals with Al and/or B, and
a second topcoat sublayer, above the first top coat sublayer, consisting essentially of silicon oxide, silicon sub-stoichiometric oxide, silicon nitride, silicon oxynitride, silicon carbide, silicon carbonitride, silicon oxycarbide, or silicon oxycarbonitride, the second topcoat sublayer having a geometrical thickness in the range 15 to 30 Å.

5. A glazing panel in accordance with claim 1, in which the first topcoat sublayer consists essentially of at least one material selected from the group consisting of titanium, titanium oxide, titanium sub-stoichiometric oxide, titanium nitride and titanium oxynitride.

6. A glazing panel in accordance with claim 5, in which the first topcoat sublayer consists essentially of at least one material selected from the group consisting of titanium, titanium oxide and titanium nitride.

7. A glazing panel in accordance with claim 1, in which the second topcoat sublayer is in direct contact with the first topcoat sublayer.

8. A glazing panel in accordance with claim 1, in which the second topcoat sublayer is exposed to air.

9. A glazing panel in accordance with claim 1, in which the first topcoat sublayer has a geometrical thickness in the range 20 to 100 Å.

10. A glazing panel in accordance claim 9, in which the first topcoat sublayer has a geometrical thickness in the range 20 to 80 Å.

11. A glazing panel in accordance with claim 1, in which the topcoat layer comprises a first topcoat sublayer consisting essentially of titanium nitride and a second topcoat sublayer consisting essentially of silicon oxide.

12. A glazing panel in accordance with claim 11, in which the sublayer consisting essentially of titanium nitride has a geometrical thickness in the range 20 to 40 Å and the sublayer consisting essentially of silicon oxide has a geometrical thickness in the range 15 to 25 A.

13. A glazing panel in accordance with claim 1, in which the glazing panel is heat-treatable.

14. A glazing panel in accordance with claim 1, in which at least one of the antireflective layers comprises an oxide.

15. A glazing panel in accordance with claim 1, in which at least one of the antireflective layers comprises a mixed oxide of zinc and one or more of tin, aluminium and titanium.

16. A glazing panel in accordance with claim 1, carrying a coating stack comprising in sequence at least:
a glass substrate
a base antireflective layer
a first infra-red reflecting layer
a central antireflective layer
a second infra-red reflecting layer
a top antireflective layer
a top coat layer

17. A glazing panel in accordance with claim 1, comprising in sequence at least:
a glass substrate;
a base antireflective layer comprising at least one layer comprising a mixed oxide of zinc and tin;
an infra-red reflecting layer;
a barrier layer;
a top antireflective layer comprising at least one layer comprising a mixed oxide of zinc and tin; and
a top coat layer comprising in sequence a first sublayer consisting essentially of titanium nitride and a second sublayer consisting essentially of silicon oxide.

18. A glazing panel in accordance with claim 17, in which the barrier layer is selected from the group consisting of a barrier layer in substantially metallic form and a barrier layer comprising a first barrier layer in substantially metallic form and an overlying second barrier layer of a different composition from the first barrier layer which is in a form selected from the group consisting of oxides, sub-stoichiometric oxides, nitrides, sub-stoichiometric nitrides, oxynitrides and sub-stoichiometric oxynitrides.

19. A glazing panel in accordance with claim 17, in which the barrier is selected from the group consisting of a barrier layer comprising titanium and a barrier layer comprising a first barrier layer comprising nickel and chromium and an overlying second barrier layer comprising titanium.

20. A glazing panel in accordance with claim 1, in which the coated glazing panel has a luminous transmittance of greater than 70%.

21. A glazing panel in accordance with claim 1, in which a heat treatment provokes an increase in the luminous transmittance of the glazing panel.

22. A glazing panel in accordance with claim 1, which is adapted for assembly in a double glazing unit.

23. A glazing panel in accordance with claim 22, in which the glazing panel is adapted to be heat treated prior to assembly in a double glazing unit.

24. A glazing panel in accordance with claim 1, which shows a AWRT score of at least 250.

25. A double glazing unit comprising at least one glazing panel in accordance with claim 1.

26. A double glazing unit comprising at least one heat-treated glazing panel in accordance with claim 1.

27. A double glazing unit in accordance with claim 25, in which the double glazing unit has a luminous transmittance of greater than 70%.

28. A method of manufacturing a heat treated glazing panel comprising the steps of, in order:
a) depositing a coating stack on a glass substrate to provide an intermediate glazing panel according to claim 1
b) subjecting the coated, intermediate glazing panel to a heat treatment process in air at a temperature of greater than 550° C.

29. A method in accordance with claim 28, in which the luminous transmittance of the heat treated glazing panel following the step of heat treatment is greater than the luminous transmittance of the intermediate glazing panel by at least 6%.

30. Use of a top coat layer comprising at least two sublayers:
a first topcoat sublayer consisting essentially of at least one material selected from the group consisting of Ti, Zr, Hf, V, Nb, Ta, Cr or their mixtures or a mixture of at least one of those metals with Al and/or B or an oxide, a sub-stoichiometric oxide, a nitride or an oxynitride of Ti, Zr, Hf, V, Nb, Ta, Cr or their mixtures, or an oxide, a sub-stoichiometric oxide, a nitride or an oxynitride which is a mixture of at least one of those metals with Al and/or B, and
a second topcoat sublayer, above the first top coat sublayer, consisting essentially of silicon oxide, silicon sub-stoichiometric oxide, silicon nitride, silicon oxynitride, silicon carbide, silicon carbonitride, silicon oxycarbide, or silicon oxycarbonitride, to enhance the mechanical resistance before heat treatment of a heat treatable coated glazing panel having at least one metallic infra red reflecting coating layer sandwiched between dielectric layers and to reduce the number of scratches visible at the surface of the coated glazing panel after heat treatment.

31. Use of a top coat layer according to claim 30, in which the second topcoat sublayer has a geometrical thickness in the range 15 to 30 Å or in the range 200 to 400 Å,

32. A method of manufacturing a glazing panel having a haze of less than about 0.5 comprising the step of subjecting a glazing panel in accordance with claim 1 to a tempering and/or bending operation at least 570° C.

33. A glazing panel carrying a coating stack comprising in sequence at least:
a glass substrate
a base antireflective layer
an infra-red reflecting layer
a top antireflective layer
a top coat layer
in which the top coat layer consists essentially of silicon oxide, silicon sub-stoichiometric oxide, silicon nitride, silicon oxynitride, silicon carbide, silicon carbonitride, silicon oxycarbide, or silicon oxycarbonitride or mixtures thereof, having a geometrical thickness selected from the ranges 15 to 30 Å.

34. A glazing panel carrying a coating stack comprising in sequence at least:
a glass substrate
a base antireflective layer
an infra-red reflecting layer
a top antireflective layer
a top coat layer
in which the top coat layer consists essentially of silicon oxide, silicon sub-stoichiometric oxide, silicon oxynitride, silicon carbide, silicon carbonitride, silicon oxycarbide, or silicon oxycarbonitride or mixtures thereof, having a geometrical thickness selected from the ranges 200 to 400 Å.
